(19) United States
(12) Patent Application Publication
(10) Pub. No.: US 2006/0119965 A1
(43) Pub. Date: Jun. 8, 2006

(54) Information recording device using patterned medium and control method thereof

(75) Inventor: Jun Ohno, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., AZ Amsterdam (NL)

(21) Appl. No.: 11/293,053

(22) Filed: Dec. 2, 2005

(30) Foreign Application Priority Data
Dec. 3, 2004 (JP) 2004-351189

(51) Int. Cl. G11B 5/09

(52) U.S. Cl. 360/51

(57) ABSTRACT

Embodiments of the invention provide an information recording device that can control the timing of information recording on a patterned medium, with a simplified configuration, and a control method for the information recording device. In one embodiment, an information recording device is provided which has a read/write head opposed to a patterned medium and moving in a relative form with respect to the patterned medium and is used to record information on the patterned medium. In accordance with a signal that the read/write head reads out from the patterned medium, a clock signal generator generates a clock signal pertaining to the timing in which the read/write head moves above the recording regions of the patterned medium, and information is recorded on the patterned medium in accordance with the information recording timing of the read/write head that has been determined in the relationship with the above-generated clock signal.

### CROSS-REFERENCES TO RELATED APPLICATIONS

This application claims priority from Japanese Patent Application No. JP2004-351189, filed Dec. 3, 2004, the entire disclosure of which is incorporated herein by reference.

### BACKGROUND OF THE INVENTION

The present invention relates to an information recording device such as a hard disk, and a control method for the same, and more particularly, to an information recording device using a patterned medium, and a control method for the same.

In recent years, the so-called “patterned medium” with magnetic islands arrayed as recording regions in a nonmagnetic material in accordance with desired patterns is developed as a most effective medium for implementing the improvement of an S/N ratio and that of thermal decay characteristics at the same time.

To record information on this patterned medium, a recording head must record the information in the timing when it arrives at a magnetic island. Accordingly, as laid-open in Patent Reference 1 (Japanese Patent Laid-Open No. 2003-281701), studies have long been performed on a magnetic recording device that detects any leakage fluxes of the magnetic field formed for information recording, and controls recording timing in accordance with detection results on the leakage fluxes.

### BRIEF SUMMARY OF THE INVENTION

With the above conventional magnetic recording device that controls recording timing in accordance with detection results on the leakage fluxes, these leakage fluxes cannot always be detected at an accuracy level high enough for the control.

The present invention was made in view of the above situation, and one feature of the invention is to provide an information recording device that can control the timing of information recording on a patterned medium, with a simplified configuration, and a control method for the information recording device.

The present invention for solving the above-mentioned problem with the conventional example relates to an information recording device that has a patterned medium and a read/write head opposed to the patterned medium and moving in a relative form with respect thereto and is used to record information on the patterned medium. The information recording device includes: a signal generator which, in accordance with a signal that the read/write head reads out from the patterned medium, generates a clock signal pertaining to the timing in which the read/write head moves above the recording regions of the patterned medium; and a timing determination section which, in the relationship with the clock signal generated above, gives at least one instruction to determine specific timing for the read/write head to record the information.

### BRIEF DESCRIPTION OF THE DRAWINGS

FIG. 1 is a construction block diagram of the information recording device according to the present embodiment of the invention.

FIG. 2 is an explanatory diagram schematically showing the read/write head.

FIG. 3 is an explanatory diagram representing examples of recorded data, a read-back signal, and a clock signal.

FIG. 4 is a flowchart representing an example of the process for the determination of recording timing.

FIG. 5 is an explanatory diagram representing an example of a table of the phase data obtained as a result of a recording trial.

FIG. 6 is an explanatory diagram representing an example of a database in which the phase data obtained as a result of a recording trial is defined for each track group.

### DETAILED DESCRIPTION OF THE INVENTION

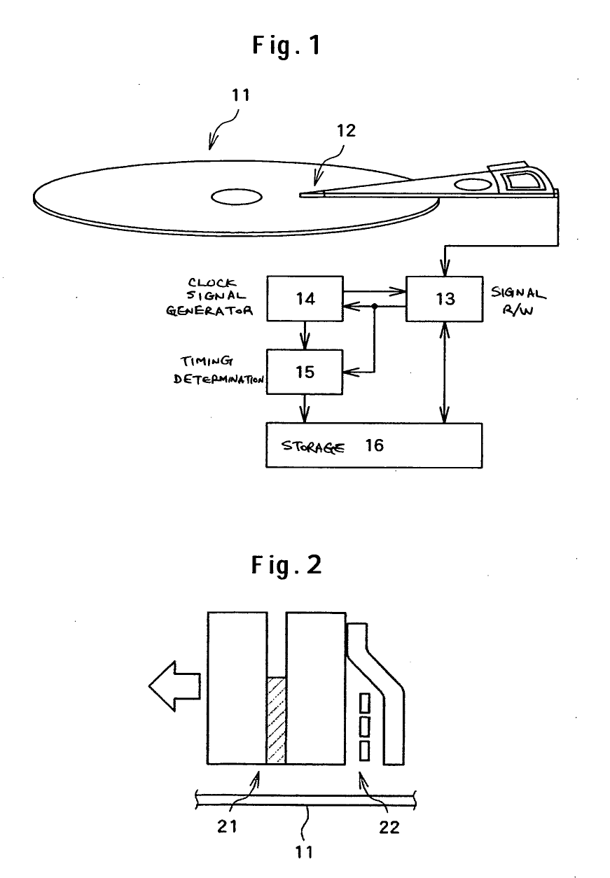

Embodiments of the present invention will be described hereunder with reference to the accompanying drawings. An information recording device according to the present embodiment includes, as shown in FIG. 1, a patterned medium 11, a read/write head 12, a signal read/write section 13, a clock signal generator 14, a timing determination section 15, and a storage section 16. FIG. 1 is a construction block diagram of the information recording device according to the present embodiment of the invention. In FIG. 1, the storage section 16 is, for example, a non-volatile memory such as a flash memory.

The patterned medium 11 is a disc-shaped magnetic recording medium having magnetic islands periodically arrayed as recording regions along tracks in a nonmagnetic material. The read/write head 12 is opposed to the patterned medium 11 and moves in a relative form with respect thereto. As shown in FIG. 2, the read/write head 12 has a read head section 21 and a write head section 22. The read head section 21 and the write head section 22 are spaced from each other at a required interval in the direction that the read/write head 12 moves in a relative form above the patterned medium, i.e., in the direction marked with an arrow in FIG. 2. FIG. 2 is an explanatory diagram schematically showing the read/write head 12.

The signal read/write section 13 is a read/write channel in a hard-disk device, for example. The signal read/write section 13 generates a read-back signal by conducting a PRML (Partial Response Maximum Likelihood) process or the like in accordance with a signal that has been read out from the patterned medium 11 by the read/write head 12. Next, the signal read/write section 13 reads data by decoding the read-back signal, and outputs the data. In the present embodiment, the signal read/write section 13 outputs the generated read-back signal and receives an input of a clock signal from the clock signal generator 14.

Also, the signal read/write section 13 receives an input of the data that is to be recorded, and encodes the data. After generating a recording signal based on the encoded data, the signal read/write section 13 outputs the signal to the read/write head 12 and records information on the pattern medium 11. In the present embodiment, timing in which the recording signal is output to the read/write head 12 is defined by the timing determination section 15 detailed later herein.

In accordance with an instruction input from the timing determination section 15, the signal read/write section 13 according to the present embodiment outputs the recording signal in the timing delayed (or advanced) by a specified phase with respect to a reference phase position of the clock signal.

The clock signal generator 14 has a narrow-band filter circuit. The narrow-band filter circuit here functions as a band-pass filter that allows passage of the signals having a required width of frequency band whose central frequency is equivalent to a period at which the read/write head 12 passes over recording regions of the patterned medium. The central frequency can be calculated from forming conditions of the recording regions and a circumferential velocity of the patterned medium beforehand.

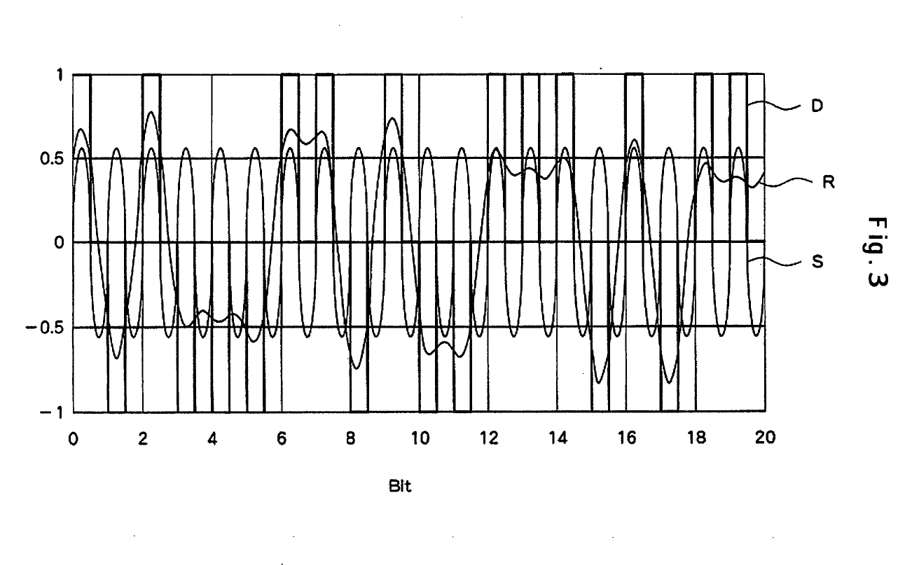

The clock signal generator 14 activates the narrow-band filter circuit to filter the read-back signal output from the signal read/write section 13, and then outputs filtering results. A more specific example of a signal is described hereunder with reference to FIG. 3. As shown in FIG. 3, the read-back signal output from the signal read/write section 13 becomes a curvilinear signal R having a peak in a direction of data D recorded. The clock signal generator 14 uses the narrow-band filter circuit to filter the signal R and thus obtains a sine wave S. The sine wave S, the output signal of the narrow-band filter circuit, is a sine wave that as shown in FIG. 3, takes a required phase at a positive peak position (upper peak position) or the like when the read/write head 12 passes above a recording region of the patterned medium. This sine wave signal serves as the clock signal in the present embodiment.

An example of generating a clock signal using the narrow-band filter circuit has been described above. Besides this method, an FIR (Finite Impulse Response) filter process or a required filter process may be used to generate the clock signal in accordance with the read signal that the signal read/write section 13 outputs.

The timing determination section 15 receives an input of the clock signal from the clock signal generator 14 and then tries recording information on the patterned medium 11 while varying a relative phase φ with respect to a reference phase position of the clock signal. The reference phase position here indicates the required phase mentioned above, and more specifically, in the example of FIG. 3, the reference phase position here indicates a phase associated with the upper peak position of the clock signal.

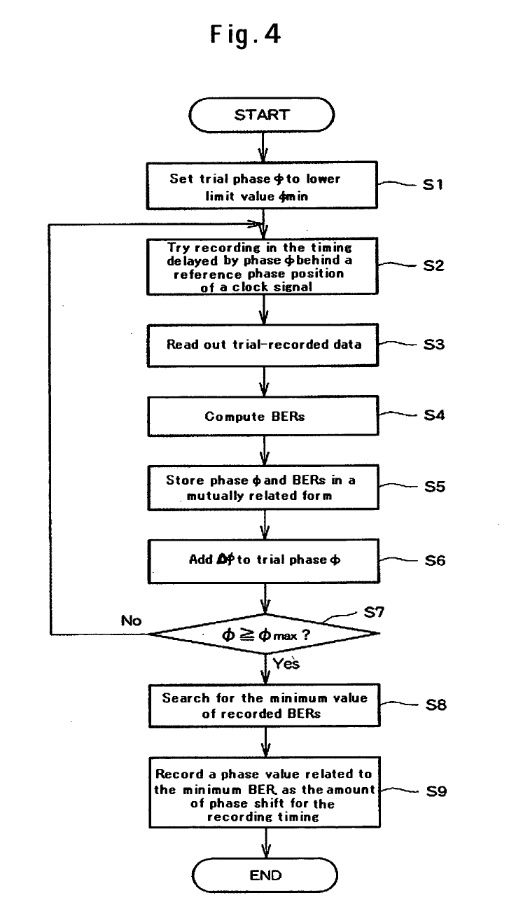

More specifically, the timing determination section 15 performs the process shown in FIG. 4. FIG. 4 is a flowchart showing an example of a recording timing determination process. That is to say, in step S1, the timing determination section 15 sets the trial phase φ to a lower limit value φmin of a predefined phase range. Then in step S2, the timing determination section 15 instructs the signal read/write section 13 to record at least one desired set of data in the timing delayed by the set phase φ behind the reference phase position of the clock signal. The recording of the desired data is conducted in a region not having a recorded substantive section of user data. In this case, since movement of the read head section 21 precedes that of the write head section 22, the desired data is recorded in the timing delayed by phase φ. If the movement of the write head section 22 precedes that of the read head section 21, however, the desired data is recorded in the timing advanced by phase φ.

Next, the timing determination section 15 activates the signal read/write section 13 to read out the above-recorded desired data in step S3. In step S4, the timing determination section 15 compares the data output from the signal read/write section 13, and the above-recorded desired data, and computes bit error rates (BERs). In step S5, the timing determination section 15 relates a current setting of phase value φ to the error bit rates and stores all related values into the storage section 16.

Next, the timing determination section 15 adds a required value of Δφ to the current setting of phase value φ in step S6, and then in step S7, examines whether the phase value φ obtained after the above addition has been conducted is greater than an upper limit value φmax of the predefined phase range. If the phase value φ existing after the addition is not greater than the upper limit value φmax of the predefined phase range (i.e., if examination results are “No”), the timing determination section 15 returns to process step S2 to continue the process.

If, in process step S7, the phase value φ existing after the addition is greater than the upper limit value φmax of the predefined phase range (i.e., if examination results are “Yes”), the timing determination section 15 proceeds to step S8 and searches for a minimum error bit rate of all those which were stored into the storage section 16. After that, the timing determination section 15 proceeds to step S9, in which a phase value φ related to the minimum error bit rate is then stored as the amount of phase shift for the recording timing, into the storage section 16 by the timing determination section 15 to complete the process.

In other words, the timing determination section 15 tries recording information while varying the phase of the information recording timing with respect to the clock signal generated by the clock signal generator 14. Then in accordance with error bit rates of the information recorded for trial above, the amount of phase shift for the recording timing is defined for the generated clock signal. This amount of phase shift becomes information recording timing of the read/write head 12.

Prior to recording information, the signal read/write section 13 reads out, from the storage section 16, information on the amount of phase shift for the recording timing. When recording information, the signal read/write section 13 outputs a recording signal in the timing delayed by the above-read amount of phase shift, with respect to the reference phase position of the clock signal.

Operation of the information recording device according to the present embodiment of the invention will be described next. When it is used, the information recording device according to the present embodiment is connected to, for example, a host computer or is directly connected to a network. An example of connection to a host computer is described hereunder. When manufactured, the information recording device according to the present embodiment is instructed from a host computer apparatus to adjust recording timing and performs an adjustment process for information recording timing. The recording timing may be readjusted when formatting is conducted.

When the information recording device according to the present embodiment is powered on, the read/write head 12 reads out a signal from the patterned medium 11 and outputs the signal. The signal read/write section 13 generates a read-back signal by conducting a PRM process (or the like) for the signal that has been read out above. The clock signal generator 14 then activates the narrow-band filter circuit to filter the read-back signal output from the signal read/write section 13, and outputs the signal as a clock signal.

At this time, when instructed from the host computer apparatus to adjust recording timing, the timing determination section 15 sets the phase φ that defines recording timing, to the lower limit value φmin of the predefined phase range. After this, the timing determination section 15 instructs the signal read/write section 13 to record at least one desired set of data in the timing delayed by the set phase φ with respect to the above-mentioned reference phase position of the clock signal.

In accordance with an instruction input from the timing determination section 15, the signal read/write section 13 records at least one desired set of data in the timing delayed by the set phase φ behind the reference phase position of the clock signal. The recording of the desired data is conducted in a region not having a recorded substantive section of user data.

The timing determination section 15 activates the signal read/write section 13 to read out the above-recorded desired data, compares the data read out from the signal read/write section 13 with the above-recorded desired data, and computes bit error rates. After this, the timing determination section 15 relates a current setting of phase value φmin to the error bit rates and stores all related values into the storage section 16.

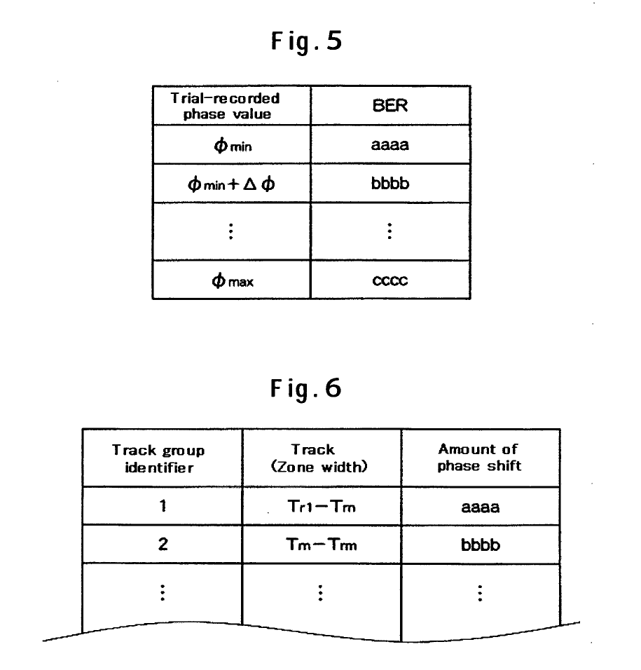

Subsequently, while incrementing phase φ by Δφ, the timing determination section 15 repeats the above process until phase φ has exceeded the upper limit value φmax of the predefined phase range. Thus, bit error rates that have been related to a plurality of phase data candidates are recorded in the storage section 16, as shown in FIG. 5.

The timing determination section 15 searches for a minimum error bit rate of all those which were stored into the storage section 16. After that, a phase value φ related to the minimum error bit rate is then stored as the amount of phase shift for the recording timing, into the storage section 16 by the timing determination section 15. This completes the adjustment process for the information recording timing.

After the adjustment process for the information recording timing, the information recording device according to the present embodiment operates as follows: first, the signal read/write section 13 reads out, from the storage section 16, information on the amount of phase shift for the recording timing.

Next after receiving a data readout instruction from the host computer apparatus, the signal read/write section 13 generates a read-back signal by conducting a PRML process (or the like) for a signal that has been read out from the patterned medium 11 by the read/write head 12, then reads data by decoding the read-back signal, and outputs the data to the host computer.

Also, when a data write instruction and data to be recorded are input from the host computer apparatus, the signal read/write section 13 encodes the input data. Next, the signal read/write section 13 generates a recording signal based on the encoded data, and outputs the signal to the read/write head 12 each time the phase of the clock signal equals a phase delayed by the amount of phase shift, behind a reference phase position (e.g., an upper peak position) of the clock signal. After this, the read/write head 12 records on the patterned medium 11 the information indicated by the recording signal that is input.

In this way, the information recording device according to the present embodiment generates a clock signal from the read-back signal read out from the patterned medium 11. The timing of information recording by the read/write head 12 is determined in the relationship with the generated clock signal. The signal read out from the patterned medium 11 is the so-called read-back signal, which is a reliably readable signal. In the present embodiment, since control of recording timing is based on a signal that can thus be reliably read, the timing of information recording on the patterned medium can be controlled with a simplified configuration.

An example based on the signal that the read/write head 12 obtains by reading an arbitrary section of the patterned medium when a clock signal is generated has been described heretofore. However, depending on particular details or type of the information recorded on the patterned medium, there could be a case in which it is difficult for the narrow-band filter circuit to generate the clock signal. In the present embodiment, therefore, the read/write head 12 may generate the clock signal in accordance with the signal read out from a section in which definite information is continuously recorded on the patterned medium 11.

In that case, when the clock signal is generated, the signal read/write section 13 controls the read/write head 12 to read the section in which the definite information is continuously recorded. Thus, the read/write head 12 generates a read-back signal based on the signal that has been read from that section, and outputs the read-back signal to the clock signal generator 14.

Examples of a section in which the definite information is continuously recorded include a direct-current erased section and a Sync (synchronization) mark section indicative of respective starting positions of servo data and user data.

The read-back signal thus read out from a section in which the definite information is continuously recorded is originally a signal close to a clock signal. A highly accurate clock signal can therefore be generated by filtering the read-back signal by means of the narrow-band filter circuit. In this case, a clock signal is not always generated in accordance with a read-back signal. Instead, a clock signal that has been generated in accordance with a read-back signal may be output in a sustained form by use of, for example, a phase-locked loop circuit or the like.

In addition, although the description heretofore given assumes that one amount of phase shift is computed for the entire disk of the patterned medium, the present embodiment is not limited to the assumption. For example, it may be possible to split a plurality of tracks on the patterned medium into a plurality of track groups, define independent amounts of phase shift for each track group, and determine the recording timing to be applied to recording information on the tracks belonging to a particular track group.

More specifically, in the timing determination section 15, the process shown in FIG. 4 is first conducted for the first track present on the innermost surface (or the outermost surface). In other words, information recording on the first track of the innermost surface (or the outermost surface) is tried (in process step S2, S3, of FIG. 4) and the amount of phase shift φ1 is determined for the first track. Next, the timing determination section 15 instructs the signal read/write section 13 to record at least one desired set of data on the second track in the timing delayed by the amount of phase shift φ1 determined above for the first track, behind the above-mentioned reference phase position of the clock signal.

Next, the timing determination section 15 activates the signal read/write section 13 to read out the above-recorded desired data, compares the data read out from the signal read/write section 13, with the above-recorded desired data, and computes bit error rates. If these bit error rates include one less than a predefined threshold value, the amount of phase shift φ2 for the second track is set to be the same as φ1.

Thus, the first track and the second track are taken as belonging to the same track group. For example, a track group identifier is issued, information that identifies the first and second tracks is related to the track group identifier, and the information is stored into the storage section 16. Also, this track group identifier is retained in the form where it is related to the amount of phase shift φ1 that was determined for the first track.

In a manner similar to the above, the timing determination section 15 subsequently instructs the signal read/write section 13 to record at least one desired set of data on an i-th track in the timing delayed by the amount of phase shift φ-1 determined for a track numbered “i-1”, behind the above-mentioned reference phase position of the clock signal.

Next, the timing determination section 15 activates the signal read/write section 13 to read out the above-recorded desired data, compares the data read out from the signal read/write section 13 with the above-recorded desired data, and computes bit error rates. If these bit error rates include one less than a predefined threshold value, the amount of phase shift φi for the i-th track is set to be the same as φ-1. After this, information that identifies the i-th track is related to an identifier of a track group to which the track numbered “i-1” belongs, and the information is retained in the storage section 16.

Conversely if the computed bit error rates computed after the above-recorded desired data has been read out by the signal read/write section 13 and then compared with the data output therefrom include one not less than the predefined threshold value, the process shown in FIG. 4 is conducted for the i-th track. That is to say, information recording on the i-th track is tried (in process step S2, S3, of FIG. 4) and the amount of phase shift φi is determined for the i-th track.

In this case, the timing determination section 15 issues a unique track group identifier, relates information that identifies the i-th track, to the track group identifier, and stores the information into the storage section 16. Also, the amount of phase shift φi that was determined for the i-th track is related to the track group identifier and then stored into the storage section 16.

A phase shift quantity database in which track group identifiers, information that identifies the tracks belonging to each track group, and the amounts of phase shift are related to each other as shown in FIG. 6 is retained in the storage section 16 as a result of the above process.

In short, tracks for which the recording timing of the information is defined with the same amount of phase shift are related to each other to form a track group (zone width). In addition, independent amounts of phase shift are defined for each track group.

When the amount of phase shift is thus defined for each track group, the signal read/write section 13 receives from the host computer apparatus a data write instruction and an input of data to be recorded, encodes the input data, and generates a recording signal based on the encoded data. The signal read/write section 13 next reads out the amount of phase shift that was stored within the storage section 16 in the form where the particular amount was related to a track group assigned to tracks on which the recording signal is to be recorded. Next, the signal read/write section 13 outputs the generated recording signal to the read/write head 12 each time the phase of the clock signal equals a phase delayed by the amount of phase shift, behind a reference phase position (e.g., an upper peak position) of the clock signal. The read/write head 12 then records on the patterned medium 1 the information indicated by the recording signal that is input.

Additionally, although, in the above example, the amounts of phase shift are stored into the storage section 16, these values may be recorded not only on this section, but also on a desired section of the patterned medium at the same time.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. An information recording device that has a patterned medium and a read/write head opposed to said patterned medium and moving in a relative form with respect thereto and is used to record information on said patterned medium, said information recording device comprising:
a signal generator which, in accordance with a signal that said read/write head reads out from said patterned medium, generates a clock signal pertaining to timing in which said read/write head moves above recording regions of said patterned medium; and
a timing determination section which, in a relationship with the clock signal generated, gives at least one instruction to determine specific timing for said read/write head to record information.

2. The information recording device according to claim 1, wherein:
said timing determination section tries information recording while varying a phase of the information recording timing, with respect to the generated clock signal to provide trial-recorded information, and
in accordance with bit error rates on the trial-recorded information, defines an amount of phase shift for the information recording timing, with respect to the generated clock signal, and determines the information recording timing of said read/write head.

3. The information recording device according to claim 2, wherein:
said timing determination section defines independent amounts of phase shift for track groups each including at least one track, and determines the information recording timing of said read/write head for each track group.

4. The information recording device according to claim 1, wherein:
said signal generator uses the signals that said read/write head reads out from both a Sync (synchronization) mark section recorded on said patterned medium, and a section in which definite information is continuously recorded, or from one of the two sections.

5. The information recording device according to claim 1, wherein:
said signal generator has a narrow-band filter circuit for filtering the signals read out from said read/write head, and generates the clock signal in response to an output signal of said narrow-band filter circuit.

6. An information recording device that has a patterned medium and a read/write head opposed to said patterned medium and moving in a relative form with respect thereto and is used to record information on said patterned medium, said information recording device comprising:
a signal generator which, in accordance with a signal that said read/write head reads out from said patterned medium, generates a clock signal pertaining to timing in which said read/write head moves above recording regions of said patterned medium;
wherein, information is recorded on said patterned medium in accordance with information recording timing of said read/write head determined in a relationship with the clock signal generated.

7. The information recording device according to claim 6, wherein:
said signal generator uses the signals that said read/write head reads out from both a Sync (synchronization) mark section recorded on said patterned medium, and a section in which definite information is continuously recorded, or from one of the two sections.

8. The information recording device according to claim 6, wherein:
said signal generator has a narrow-band filter circuit for filtering the signals read out from said read/write head, and generates the clock signal in response to an output signal of said narrow-band filter circuit.

9. A method for controlling an information recording device that has a patterned medium and a read/write head opposed to the patterned medium and moving in a relative form with respect thereto and is used to record information on the patterned medium, said method comprising:
generating, in accordance with a signal that the read/write head reads out from the patterned medium, a clock signal pertaining to timing in which the read/write head moves above recording regions of the patterned medium; and
making, in a relationship with the clock signal generated, a determination of timing of information recording on the patterned medium for controlling the timing of information recording on the patterned medium.

10. The method according to claim 9, further comprising:
trying information recording while varying a phase of the information recording timing, with respect to the generated clock signal to provide trial-recorded information, and
in accordance with bit error rates on the trial-recorded information, defining an amount of phase shift for the information recording timing, with respect to the generated clock signal, and determining the information recording timing of said read/write head.

11. The method according to claim 10, further comprising:
defining independent amounts of phase shift for track groups each including at least one track, and determining the information recording timing of said read/write head for each track group.

12. The method according to claim 9, further comprising:
using the signals that said read/write head reads out from both a Sync (synchronization) mark section recorded on said patterned medium, and a section in which definite information is continuously recorded, or from one of the two sections.

13. The method according to claim 9, wherein:
with a narrow-band filter circuit, filtering the signals read out from said read/write head, and generating the clock signal in response to an output signal of said narrow-band filter circuit.
